(19) United States
(12) Patent Application Publication
(10) Pub. No.: US 2026/0145601 A1
(43) Pub. Date: May 28, 2026

(54) AIR CUSHION ARRANGEMENT FOR A BACKREST OF A VEHICLE SEAT, VEHICLE SEAT, MOTOR VEHICLE

(71) Applicant: Volkswagen Aktiengesellschaft, Wolfsburg (DE)

(72) Inventors: Martin KOSCHE, Gifhorn (DE); Johann GIGGEL, Gardelegen (DE); Ralph BOETTGER, Ebendorf (DE); Viktor PETKER, Wolfsburg (DE)

(73) Assignee: Volkswagen Aktiengesellschaft, Wolfsburg (DE)

(21) Appl. No.: 19/419,681

(22) Filed: Dec. 15, 2025

Related U.S. Application Data
(63) Continuation of application No. PCT/EP2024/065534, filed on Jun. 6, 2024.

(30) Foreign Application Priority Data
Jun. 15, 2023 (DE) 10 2023 205 619.4

(51) Int. Cl. B60N 2/66; B60N 2/90

(52) U.S. Cl. CPC B60N 2/665; B60N 2/976

(57) ABSTRACT

An air cushion arrangement for a backrest of a vehicle seat with a massage function for an adjustable lumbar support of the backrest. At least a first and a second pair of air cushions, each of which can be assigned or is assigned to a back region and/or shoulder region of the backrest, wherein the air cushions of the pairs of air cushions are each designed and arranged at least substantially mirror-symmetrically to a longitudinal central axis of the air cushion arrangement. The air cushions have a longitudinal edge facing the other air cushion of the same pair of air cushions. The air cushions of the first pair of air cushions are arranged such that the longitudinal edges of the first pair of air cushions run at least approximately parallel to one another. The air cushions of the second pair of air cushions are arranged rotated relative to one another.

This nonprovisional application is a continuation of International Application No. PCT/EP 2024/065534, which was filed on Jun. 6, 2024, and which claims priority to German Patent Application No. 10 2023 205 619.4, which was filed in Germany on Jun. 15, 2023, and which are both herein incorporated by reference.

### BACKGROUND OF THE INVENTION

### Field of the Invention

The invention relates to an air cushion arrangement for a backrest of a vehicle seat, in particular with a massage function for an adjustable lumbar support of the backrest, having at least a first and a second pair of air cushions, each of which can be assigned or is assigned to a back region and/or shoulder region of the backrest, wherein the air cushions of the pairs of air cushions are each designed and arranged at least substantially mirror-symmetrically to a longitudinal central axis of the air cushion arrangement, wherein the air cushions of the pairs of air cushions each have a longitudinal edge facing the other air cushion of the same pair of air cushions, and wherein the air cushions of the first pair of air cushions are arranged in such a way that the longitudinal edges of the first pair of air cushions run at least approximately parallel to one another.

In addition, the invention relates to a vehicle seat having such an air cushion arrangement as well as to a motor vehicle having such a vehicle seat.

### Description of the Background Art

Air cushion arrangements of the abovementioned type are known from the prior art. Also known are pneumatic lumbar supports, for example for vehicle seats of motor vehicles, that permit an adjustment of the lumbar-vertebra support (lordosis) for a user-specific natural contour of the spinal column in the lumbar region (S-curve of the spinal column) via the filling of air cushions or air pockets of such air cushion arrangements. In this case, the supply of air is usually carried out by pump devices with a pump motor. Filling, air evacuation, and maintaining of the air pressure are controlled by control devices and valve arrangements.

Thus, for example, from published patent application DE 20 2019 100 710 U1 is known an air cushion device with a multiplicity of pairs of air cushions, wherein the air cushion device comprises an even number of air cushions, wherein two of the air cushions at a time are arranged in a row, in particular mirror-symmetrically. In this design, one pair of air cushions is arranged in a shoulder region of a backrest, and additional pairs of air cushions are arranged spaced apart therefrom in a (lower) back region of the backrest. The longitudinal edges of all air cushions each run parallel to one another.

### SUMMARY OF THE INVENTION

It is therefore an object of the invention to provide an improved air cushion arrangement that has further increased ergonomics for a user.

According to an example of the invention, provision is made in this case that the air cushions of the second pair of air cushions are arranged rotated relative to one another in such a way that the longitudinal edges of the second pair of air cushions form a first acute angle to the longitudinal central axis. A pair of air cushions preferably has exactly two air cushions, wherein one of the air cushions is arranged on a first side in relation to the longitudinal central axis, in particular on the left, and the other of the air cushions, is arranged, in particular at the same level, on a second side facing away from the first side, in particular on the right, in relation to the longitudinal central axis. As a result of the rotated arrangement of the air cushions to the longitudinal central axis, a sitting behavior and a massage sensation advantageously further improved are for a user of the vehicle seat. The air cushions preferably can be assigned or are assigned to a shoulder region of the backrest. The invention is based on the finding that the turning of the air cushions improves the ergonomics for the user, in particular in the shoulder region, because the contour of the air cushions is thus better adapted to the natural contour of the user's shoulder blades. Especially preferably, the air cushion arrangement as a whole can be designed substantially mirror-symmetrically to its longitudinal central axis, at least with respect to its outer contour. The air cushions have, in particular, an elastically deformable film. In particular, the air cushions can be made of two such films hermetically connected, in particular welded, to one another in a sandwich-like manner. Especially preferably, the air cushions have a thickness/depth of 5 mm at most. For example, the air cushions have a nominal thickness of 3 mm±1 mm. Preferably, at least two of the air cushions, preferably all air cushions, can be arranged or formed on a common film support. Especially preferably, the air cushions can be or are connected via tubing to a pneumatic pump arrangement, in particular an arrangement having a pump motor.

The first angle of the second pair can be a maximum of 10°, in particular lies in a range from 2° to 10°, preferably 3° to 8°. The ergonomics are especially advantageous with such an angle. Especially preferably, a nominal size of the first angle is 5.7°±2°. The two air cushions of the pair each form the first angle with the longitudinal central axis in this regard, so that the longitudinal edges of two different air cushions form a doubled first angle with one another. Preferably, the air cushions are each designed with an at least approximately rectangular shape in cross section so that the two remaining edges, which are parallel to one another, accordingly likewise form an acute angle with the longitudinal central axis, wherein this angle corresponds to the difference between a right angle and the first angle, which is to say is at least 80°, but less than 90°, in particular.

The air cushion arrangement can have a third pair of air cushions that can be assigned or is assigned to a back region and/or shoulder region of the backrest, that the air cushions of the third pair of air cushions are each designed and arranged at least substantially mirror-symmetrically to a longitudinal central axis of the air cushion arrangement and have a longitudinal edge facing the other air cushion of the third pair of air cushions, and that the air cushions of the third pair of air cushions are arranged rotated relative to one another in such a way that the longitudinal edges of the third pair of air cushions form a second acute angle to the longitudinal central axis. The ergonomics advantageously are further improved as a result, because in this regard two pairs of air cushions are provided in a rotated arrangement.

The first and the second angles can be equal in size. Owing to the equal-sized angles, the air cushion arrangement is designed especially simply in terms of geometry.

The first and the second angles can be different in size. An especially advantageous possibility for further optimized ergonomics is created via the different angles. In particular, different heights of users are taken into account by the different angles.

One of the angles, in particular the second angle, can be at least twice the size, in particular exactly twice the size, of the other of the angles, in particular the first angle. This results in the advantage that the ergonomic effect of the arrangement is especially pronounced.

The second pair of air cushions can be arranged between the first and third pairs of air cushions in relation to the longitudinal central axis. With an arrangement of this nature, the advantages of the air cushion arrangement according to the invention are especially strongly pronounced. For example, the first angle is greater than the second angle, as described above, in particular is at least twice the size or exactly twice the size, so that the more strongly rotated third pair of air cushions is located further outward, or in other words, when used as intended, is higher up or closer to the user's shoulder region, so that the ergonomics are advantageously optimized.

The air cushions of at least one of the pairs of air cushions, in particular of all pairs of air cushions, can be designed to be at least substantially identical geometrically to the air cushions of another of the pairs of air cushions, in particular of all pairs of air cushions in each case. It is advantageously ensured by this means that the respective pairs have a uniform effect on a user when the air cushions are actuated. Also, the air cushion arrangement has an advantageously simple design in terms of construction as a result, and therefore can be produced economically.

The air cushions of at least one of the pairs of air cushions, in particular of all pairs of air cushions, can each be designed with an at least approximately rectangular shape in cross section. With a rectangular shape, the advantages of the air cushion arrangement according to the invention are especially strongly pronounced. In particular, the air cushions have rounded corners. Preferably, a ratio of the edge lengths of the air cushions is at least approximately or at most 4 to 3. In particular, a distance between the edges of two air cushions is at least approximately or at most as great as one transverse or longitudinal extent, in particular one half a transverse or longitudinal extent, of the respective air cushions.

The vehicle seat for a motor vehicle can have a backrest, and is characterized in that the air cushion arrangement according to the invention can be arranged in or on the backrest, in particular in or on a seat frame. The aforementioned advantages are produced by this means. The same advantages are produced with employment of the vehicle seat in transport vehicles, for example, airplanes, as well as with a use of the air cushion arrangement according to the invention in seats that are not installed in transport vehicles, for example massage seats.

The motor vehicle can be characterized by at least one vehicle seat according to the invention. The aforementioned advantages are also produced by this means. In particular, the motor vehicle has the vehicle seat as a driver's seat.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shown an exemplary air cushion arrangement, and

FIG. 2 is a detail view of the air cushion arrangement.

### DETAILED DESCRIPTION

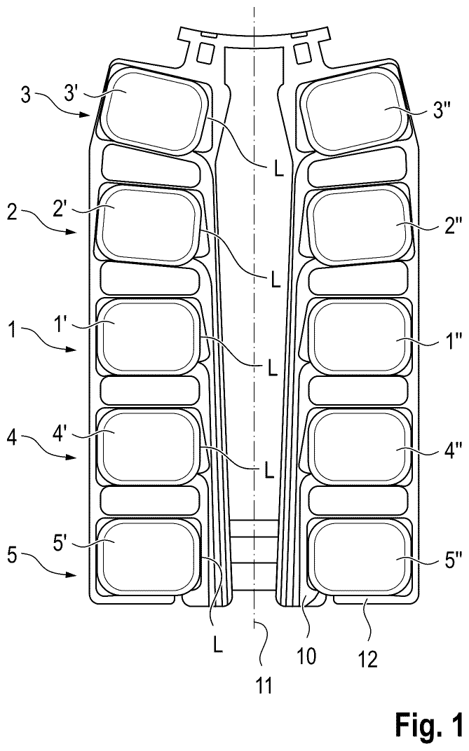

FIG. 1 shows an air cushion arrangement 10 for a backrest of a vehicle seat. The air cushion arrangement 10 is, in particular, part of a pneumatically adjustable lumbar support, for example with a massage function. The air cushion arrangement 10 has a multiplicity of pairs, in the present case five pairs, of air cushions. The pairs of air cushions each can be assigned or are assigned to a back region and/or shoulder region of the backrest.

In this case, the air cushion arrangement 10 has a first pair 1 of air cushions 1′, 1″, a second pair 2 of air cushions 2′, 2″, a third pair 3 of air cushions 3′, 3″, a fourth pair 4 of air cushions 4′, 4″, and a fifth pair 5 of air cushions 5′, 5″. The air cushions 1′-5″ of the pairs 1-5 of air cushions 1′-5″ are each designed and arranged at least substantially mirror-symmetrically to a longitudinal central axis 11 of the air cushion arrangement 10. In addition, the air cushions 1′-5″ each have an elastically deformable film and are arranged on a common film support 12.

When the air cushion arrangement 1 is used and installed as intended in

the backrest, the pairs 1-5 of air cushions 1′-5″ are arranged in the vertical direction in relation to the longitudinal central axis 11 as follows, from the top to the bottom: the third pair 3 at the very top, then the second pair 2, the first pair 1, the fourth pair 4, and the fifth pair 5 at the very bottom.

The second pair 2 and the third pair 3 can be assigned or are assigned in

this regard to a shoulder region (or an upper back region) of the backrest and thus of a user, and the first pair 1 as well as the fourth pair 4 and the fifth pair 5 to a (lower) back region of the backrest and thus of the user.

All air cushions 1′-5″ are designed identically to one another

geometrically, at least substantially, and at least with regard to their respective outer contour. The air cushions 1′-5″ are each designed with an at least approximately rectangular shape in cross section in this case. In the present case, the air cushions 1′-5″ each have rounded corners.

The air cushions 1′-5″ of the pairs 1-5 accordingly each have a longitudinal edge L facing the other air cushion 1′-5″ of the same pair 1′-5″ of air cushions 1′-5″. By way of example, one of the longitudinal edges L of an air cushion 1′-5″ of each pair 1-5 is labeled with reference symbols in each case.

According to further examples, the air cushions 1′-5″ can have cross sections that differ from a rectangular shape, wherein the air cushions 1′-5″ preferably each can have at least a longitudinal edge L facing the other air cushion 1′-5″ of the same pair 1-5, running at least in sections as a straight line. Nor is it necessary in terms of geometry for it to be a longitudinal edge that is lateral in the present case. The geometric observations described also apply to a corresponding longitudinal edge designed as a top edge or bottom edge.

The air cushions 1′,1″ of the first pair 1, the air cushions 4′,4″ of the fourth pair 4, as well as the air cushions 5′,5″ of the fifth pair 5, at least in the present case, are arranged such that all of their respective longitudinal edges L (on account of the rectangular shape) run at least approximately parallel to one another.

In contrast, the air cushions 2′,2″ of the second pair 2, as well as the air cushions 3′,3″ of the third pair 3, are each arranged rotated relative to one another in such a way that the longitudinal edges L of the second pair 2 of air cushions 2′,2″ form a first acute angle α to the longitudinal central axis 11, and that the longitudinal edges L of the third pair 3 of air cushions 3′,3″ form a second acute angle β to the longitudinal central axis 11.

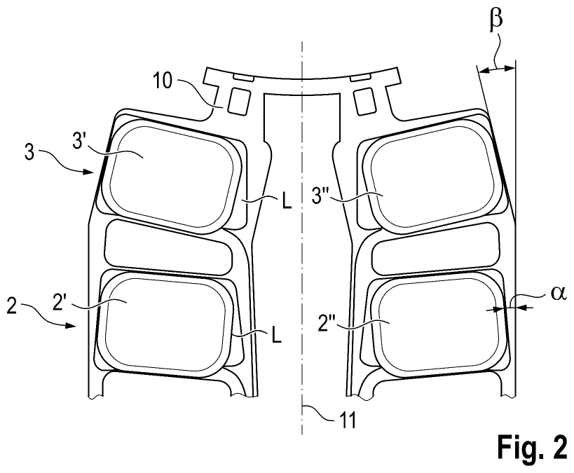

FIG. 2 shows a corresponding detail depiction of the second pair 2 and of the third pair 3 for this purpose. The first angle α in the present case is a maximum of 10°, more precisely it lies in a range from 3°to 8°. In this design, the first angle α and the second angle β are different in size. In the present case, the second angle β is exactly twice the size of the first angle α. According to an example, the angles α, β can be equal in size.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is

1. An air cushion arrangement for a backrest of a vehicle seat with a massage function for an adjustable lumbar support of the backrest, the air cushion arrangement comprising:
at least a first pair of air cushions; and
at least a second pair of air cushions, the at least first and second pair of air cushions being assignable to a back region and/or shoulder region of the backrest;
wherein the air cushions of the first and second pairs of air cushions are each designed and arranged at least substantially mirror-symmetrically to a longitudinal central axis of the air cushion arrangement,
wherein the air cushions of the first and second pairs of air cushions each have a longitudinal edge facing the other air cushion of the same pair of air cushions,
wherein the air cushions of the first pair of air cushions are arranged such that the longitudinal edges of the first pair of air cushions run at least approximately parallel to one another, and
wherein the air cushions of the second pair of air cushions are arranged rotated relative to one another such that the longitudinal edges of the second pair of air cushions form a first acute angle to the longitudinal central axis.

2. The air cushion arrangement according to claim 1, wherein the first angle of the second pair is a maximum of 10°, or lies in a range from 2° to 10°, or 3° to 8°.

3. The air cushion arrangement according to claim 1, wherein the air cushion arrangement has a third pair of air cushions that are adapted to be assigned or is assigned to a back region and/or shoulder region of the backrest, wherein the air cushions of the third pair of air cushions are each designed and arranged at least substantially mirror-symmetrically to a longitudinal central axis of the air cushion arrangement and have a longitudinal edge facing the other air cushion of the third pair of air cushions, and wherein the air cushions of the third pair of air cushions are arranged rotated relative to one another in such a way that the longitudinal edge of the third pair of air cushions form a second acute angle to the longitudinal central axis.

4. The air cushion arrangement according to claim 3, wherein the first and the second angles are equal in size.

5. The air cushion arrangement according to claim 3, wherein the first and the second angles are different in size.

6. The air cushion arrangement according to claim 5, wherein one of the angles or the second angle is at least twice the size or exactly twice the size of the other of the angles or the first angle.

7. The air cushion arrangement according to claim 3, wherein the second pair of air cushions is arranged between the first pair of air cushions and the third pair of air cushions in relation to the longitudinal central axis.

8. The air cushion arrangement according to claim 1, wherein the air cushions of at least one of the pairs of air cushions or of all pairs of air cushions are designed to be at least substantially identical geometrically to the air cushions of another of the pairs of air cushions or of all pairs of air cushions in each case.

9. The air cushion arrangement according to claim 1, wherein the air cushions of at least one of the pairs of air cushions or of all pairs of air cushions are each designed with an at least approximately rectangular shape in cross section.

10. A vehicle seat for a motor vehicle, the vehicle seat comprising:
a backrest; and
the air cushion arrangement according to claim 1, the air cushion arrangement being arranged in or on the backrest or in or on a seat frame.

11. A motor vehicle comprising at least one vehicle seat according to claim 10.
